(19) United States
(12) Patent Application Publication
(10) Pub. No.: US 2015/0192285 A1
(43) Pub. Date: Jul. 9, 2015

(54) LED Lamp String

(71) Applicant: Mei-Jung Chen, Hsinchu City (TW)

(72) Inventor: Mei-Jung Chen, Hsinchu City (TW)

(21) Appl. No.: 14/148,726

(22) Filed: Jan. 7, 2014

(51) Int. Cl. F21V 23/06; F21V 23/00; H05B 33/08; F21S 4/00

(52) U.S. Cl. CPC F21V 23/06; F21S 4/001; F21V 23/001; H05B 33/0845

(57) ABSTRACT

The LED lamp string contains a control device connected to a power plug through a power cable, a number of LED lamps through a main cable having a first port, and an auxiliary cable having a first plug. The first port of a LED lamp string therefore can be connected to the first plug of another LED lamp string. A chain of LED lamp strings therefore can be achieved in this manner. The auxiliary cable provides both signal communication and electricity transmission. Then by plugging a LED lamp string of the chain to a power source, the entire chain is powered. A control device of the LED lamp string plugged to the power source controls all LED lamps on the chain so that all LED lamps are turned on, turned off, and flashed simultaneously under the control of the single controller, thereby achieving greater visual appearance.

### BACKGROUND OF THE INVENTION

(a) Technical Field of the Invention

The present invention is generally related to lamp strings, and more particular to LED lamp strings that can be chained and whose lamps are controlled synchronously.

(b) Description of the Prior Art

As shown in FIG. 1, a conventional LED lamp string 1 mainly contains a control device 10 having a main controller IC 11 inside. The control device 10 is connected to a plug 20 through a power cable 12. The control device 10 is also connected to a number of LED lamps 40 through a main cable 30. Each LED lamp 40 contains at least a LED element 41. The main cable 30 provides both electricity transmission and signal communication for the main controller IC 11 to the LED lamps 40. The LED lamps 40 are series-connected over the main cable 30 and a port 50 is configured at a far end of the main cable 30 away from the control device 10.

As shown in FIG. 3, the conventional LED lamp string 1 can be chained with one or more additional conventional LED lamp strings 1 into an extended string of LED lamps 40. The chain of conventional LED lamp strings 1 is achieved by plugging the plug 20 of a second conventional lamp string 1 into the port 50 of a first conventional lamp string 1, the plug 20 of a third conventional lamp string 1 into the port 50 of the second conventional lamp string 1, and so on. Then, finally, the plug 20 of the first conventional LED lamp string 1 is plugged into a power source, and the entire chain of the conventional LED lamp strings 1 is powered. However as the power cable 12 can only provide electricity transmission, but not signal communication, the LED lamps 40 on a conventional LED lamp string 1 of the chain are controlled by the control device 10 of the LED lamp string 1, independent of the LED lamps 40 on the other conventional LED lamp strings 1 of the chain. Therefore, as shown in FIG. 3, the LED lamps 40 on the first, second, and third conventional LED lamp strings 1 separately form sections A, B, and C, of independent control. As such, the LED lamps 40 on the chain are turned on, turned off, and flashed by different control devices 10, and their lighting behaviors cannot be synchronized, significantly affecting the visual appealing of the chain of the LED lamps 40.

### SUMMARY OF THE INVENTION

A major objective of the present invention is to provide an auxiliary cable with a first plug on a LED lamp string having a main cable with a first port. The first port of the LED lamp string therefore can be connected to the first plug of another LED lamp string. A chain of LED lamp strings therefore can be achieved in this manner. The auxiliary cable provides both signal communication and electricity transmission. Then by plugging a power plug of a LED lamp string of the chain to a power source, the entire chain is powered. A control device of the LED lamp string plugged to the power source controls all LED lamps on the chain so that all LED lamps are turned on, turned off, and flashed simultaneously under the control of the single control device, thereby achieving greater visual appearance.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become apparent to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a schematic diagram showing a conventional LED lamp string.

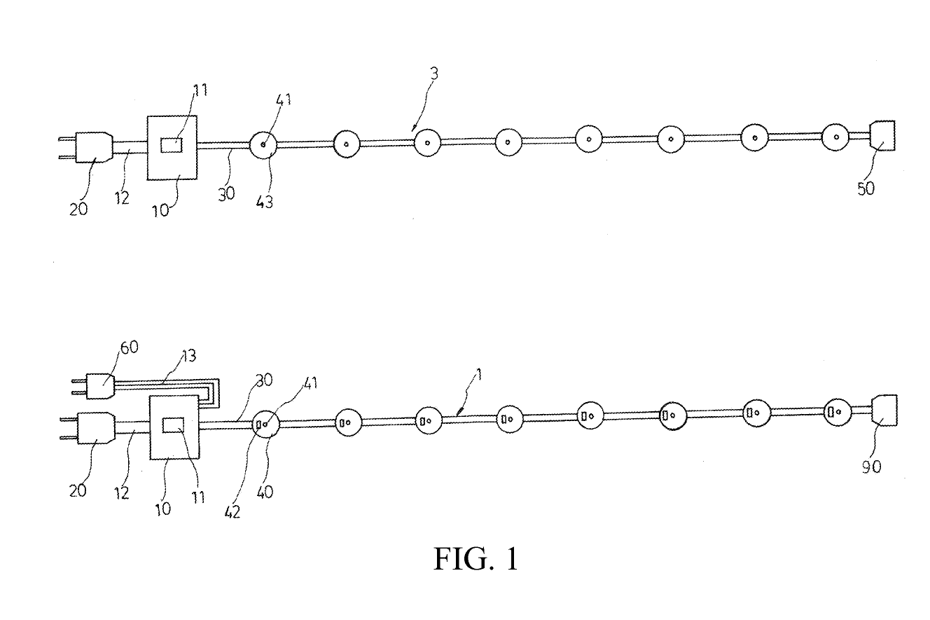

FIG. 2 is a schematic diagram showing a LED lamp string according a first embodiment of the present invention.

FIG. 3 is a schematic diagram showing a number of conventional LED lamp strings of FIG. 1 chained together.

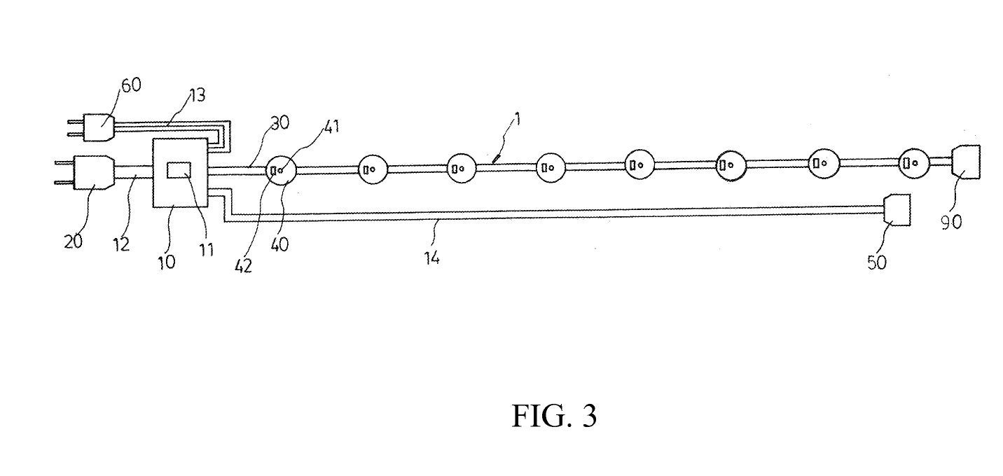

FIG. 4 is a schematic diagram showing a number of LED lamp strings of FIG. 2 chained together.

FIG. 5 is a schematic diagram showing a LED lamp string according a second embodiment of the present invention.

FIG. 6 is a schematic diagram showing a LED lamp string according a third embodiment of the present invention.

FIG. 7 is a schematic diagram showing a LED lamp string according a fourth embodiment of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

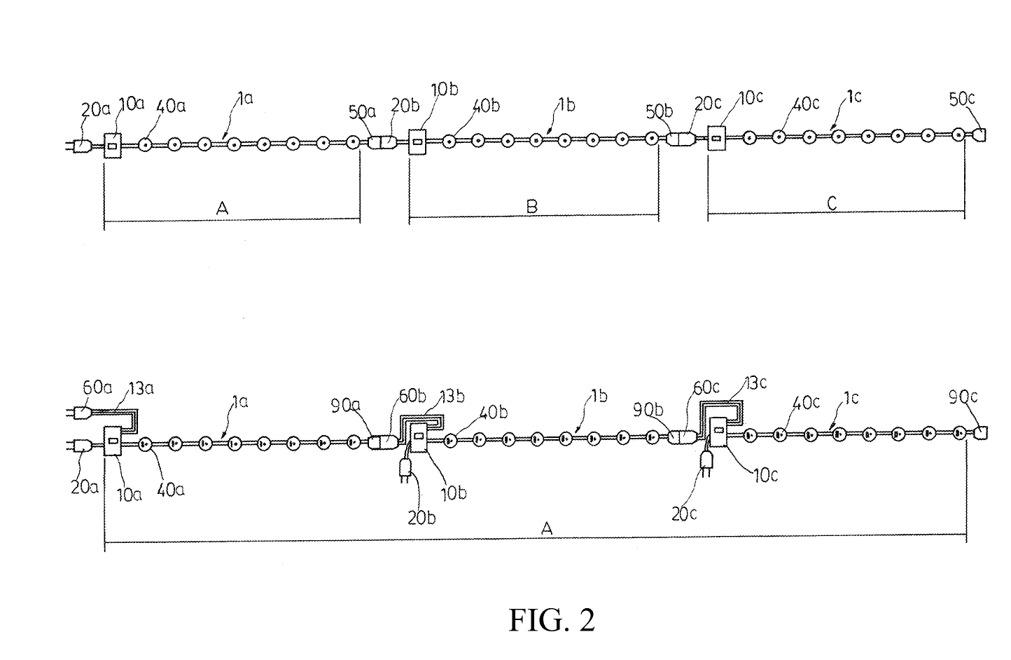

As shown in FIG. 2, a LED lamp string 1 according to a first embodiment of the present invention mainly contains a control device 10 having a main controller IC 11 inside. The control device 10 is connected to a power plug 20 through a power cable 12. The control device 10 is also connected to a number of LED lamps 40 through a main cable 30. Each LED lamp 40 contains at least a LED element 41 and an auxiliary controller IC 42. The main cable 30 provides both electricity transmission and signal communication for the main controller IC 11 to the auxiliary controller ICs 42. The LED lamps 40 are series-connected over the main cable 30 and a first port 50 is configured at a far end of the main cable 30 away from the control device 10. An inventive step of the present invention is that the control device 10 is further connected to a first auxiliary cable 13 having a first plug 60 at a far end. The first auxiliary cable 13 provides electricity transmission and signal communication for the main controller IC 11. The first port 50 and the first plug 60 are compatible connectors so that the first plug 60 can be plugged into the first port 50.

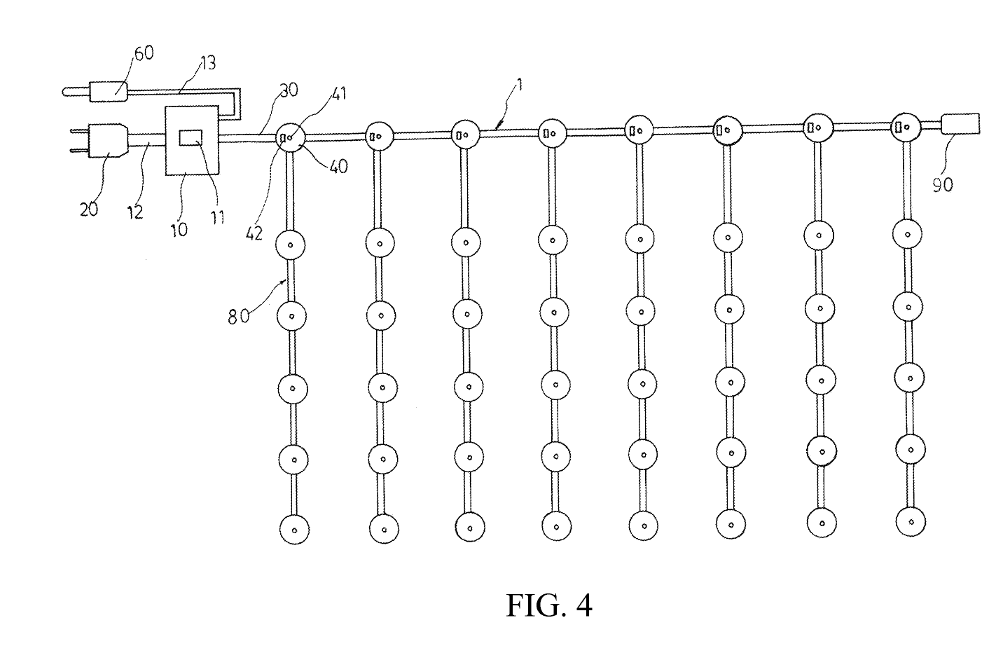

As shown in FIG. 4, the LED lamp string 1 can be chained with one or more additional LED lamp string 1 into an extended string of LED lamps 40. The chain of LED lamp strings 1 is achieved by plugging the first plug 60 of a second lamp string 1 into the first port 50 of a first lamp string 1, the first plug 60 of a third lamp string 1 into the first port 50 of the second lamp string 1, and so on. And, finally, the power plug 20 of the first lamp string 1 is plugged into a power source. Then, due to the main cables 30 of the lamp strings 1 are series-connected by the auxiliary cables 13, all LED lamps 40 on the first, second, third, . . . , lamp strings 1 are all controlled by the control device 10 of the first lamp string 1. In other words, these lamp strings 1 jointly form a section A of synchronized LED lamps 40 that are simultaneously turned on, turned off, and flashed, thereby enhancing the visual appealing of the extended string of LED lamps 40.

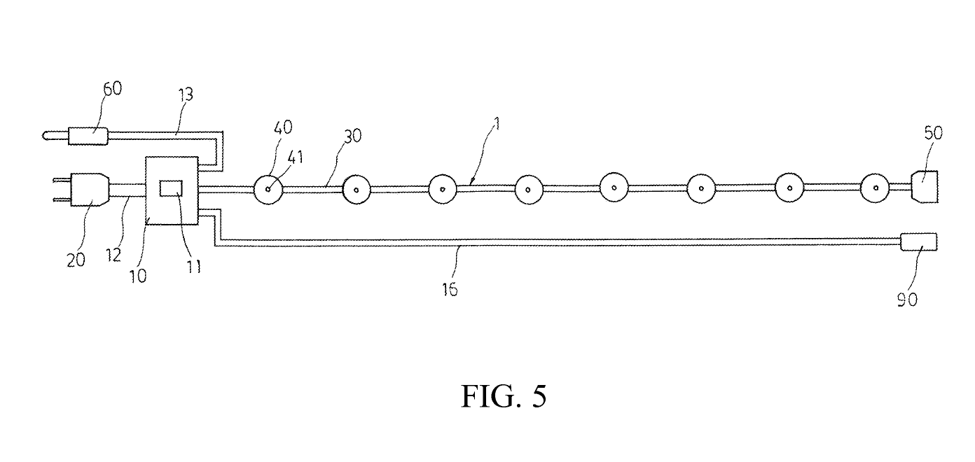

As shown in FIG. 5, a LED lamp string 1 according to a second embodiment of the present invention has a second auxiliary cable 14 connected to the control device 10 that provides only electricity transmission. The second auxiliary cable 14 has a second port 70 at a far end away from the control device 10 for the plugging of a conventional LED lamp string lacking the control device 10, thereby enhancing the flexibility of the LED lamp string 1.

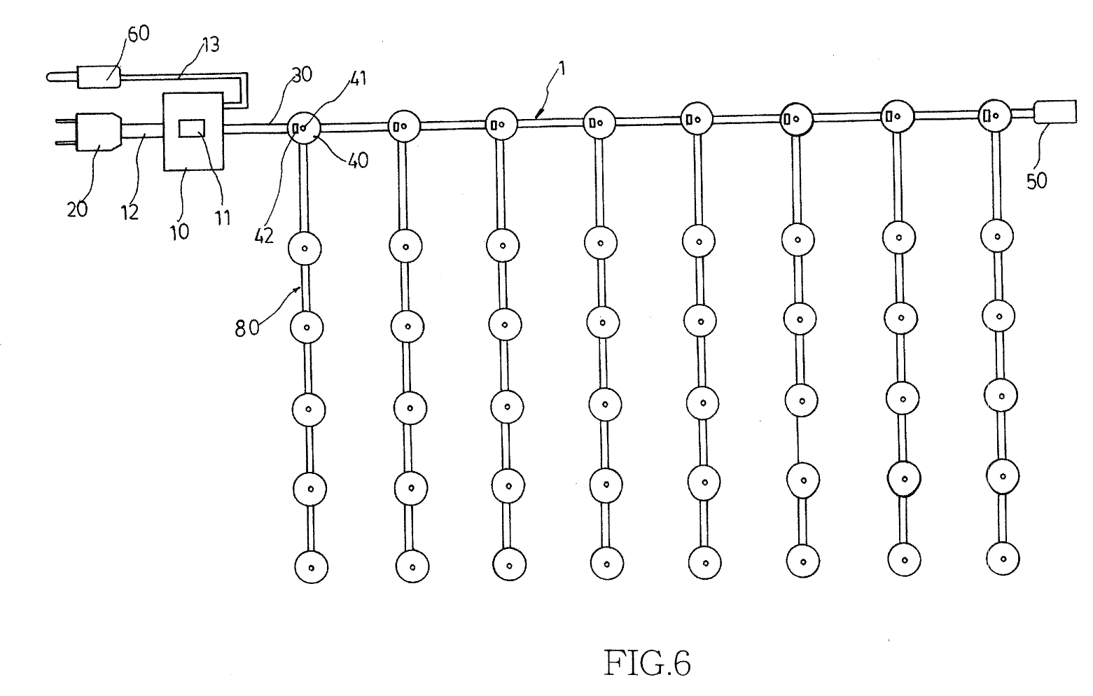

As shown in FIG. 6, a LED lamp string 1 according to a third embodiment of the present invention mainly contains a control device 10 having a main controller IC 11 inside. The control device 10 is connected to a power plug 20 through a power cable 12. The control device 10 is also connected to a number of LED lamps 40 through a main cable 30. Each LED lamp 40 contains at least a LED element 41 and an auxiliary controller IC 42. The main cable 30 provides both electricity transmission and signal communication for the main controller IC 11 to the auxiliary controller ICs 42. The LED lamps 40 are series-connected over the main cable 30 and a first port 50 is configured at a far end of the main cable 30 away from the control device 10. The control device 10 is further connected to a first auxiliary cable 13 having a first plug 60 at a far end. The first auxiliary cable 13 provides electricity transmission and signal communication for the main controller IC 11. The first port 50 and the first plug 60 are compatible connectors so that the first plug 60 can be plugged into the first port 50. Additionally, at least a LED lamp 40 is connected to a third auxiliary cable 80 along which a number of LED lamps (not numbered) without auxiliary controller IC 42 are series-connected. These LED lamps (not numbered) can be controlled by the auxiliary controller IC 42 of the LED lamp 40 they are connected to. The LED lamp string 1, together with multiple third auxiliary cables 80, will function like a lamp curtain when it is hung.

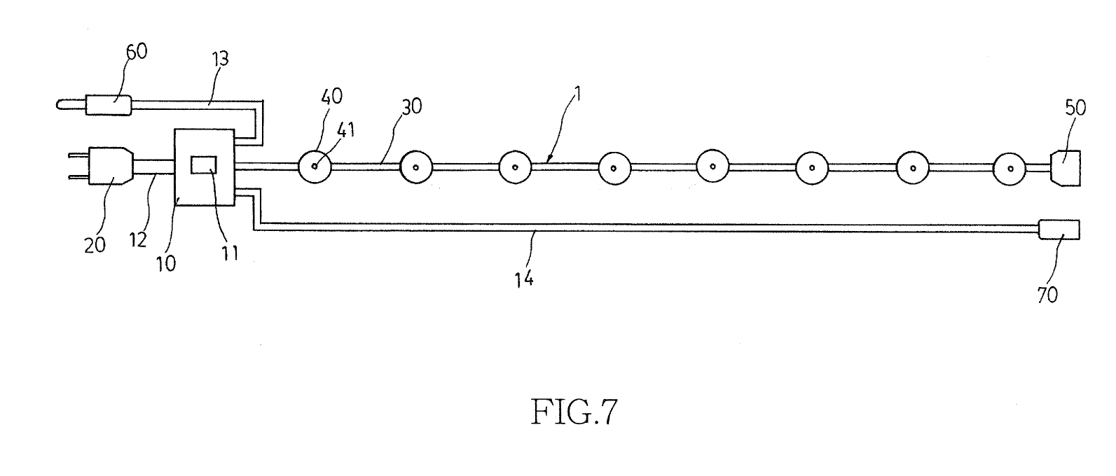

As shown in FIG. 7, a LED lamp string 1 according to a fourth embodiment of the present invention mainly contains a control device 10 having a main controller IC 11 inside. The control device 10 is connected to a power plug 20 through a power cable 12. The control device 10 is also connected to a number of LED lamps 40 through a main cable 30. Each LED lamp 40 contains at least a LED element 41 but without auxiliary controller IC 42. The LED lamps 40 are series-connected over the main cable 30 and a first port 50 is configured at a far end of the main cable 30 away from the control device 10. The control device 10 is further connected to a first auxiliary cable 13 having a first plug 60 at a far end. The first auxiliary cable 13 provides electricity transmission and signal communication for the main controller IC 11. The first port 50 and the first plug 60 are compatible connectors so that the first plug 60 can be plugged into the first port 50. Additionally, a second auxiliary cable 14 connected to the control device 10 that provides only electricity transmission. The second auxiliary cable 14 has a second port 70 at a far end away from the control device 10 for the plugging of a conventional LED lamp string lacking the control device 10, thereby enhancing the flexibility of the LED lamp string 1.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

1. A LED lamp string, comprising:
a control device having a main controller IC inside;
a power cable connected to the control device, a power plug configured at a far end of the power cable away from the control device for plugging into a power source;
a main cable connected to the control device, a first port configured at a far end of the main cable away from the control device;
a plurality of LED lamps series-connected along and on the main cable, each LED lamp comprising at least a LED element and an auxiliary controller IC; and
a first auxiliary cable connected to the control device, a first plug configured at a far end away from the control device;
wherein the main cable and the first auxiliary cable provide both electricity transmission and signal communication for the main controller IC; and
the first port and the first plug are compatible connectors so that the first plug is capable of being plugged into the first port of a separate lamp string.

2. (canceled)

3. The LED lamp string according to claim 1, further comprising:
a second auxiliary cable connected to the control device, a second port configured at a far end of the second auxiliary cable away from the control device for connecting a conventional LED lamp string lacking the control device;
wherein the second auxiliary cable provides only electricity transmission.

4. The LED lamp string according to claim 1, further comprising:
a plurality of third auxiliary cables, each connected to a LED lamp of the main cable;
wherein a plurality of LED lamps without auxiliary controller IC are series-connected along and on each third auxiliary cable.

5. A LED lamp string, comprising:
a control device having a main controller IC inside;
a power cable connected to the control device, a power plug configured at a far end of the power cable away from the control device for plugging into a power source;
a main cable connected to the control device, a second port configured at a far end of the main cable away from the control device for connecting a conventional LED lamp string lacking the control device;
a plurality of LED lamps series-connected along and on the main cable, each LED lamp comprising at least a LED element;
a first auxiliary cable connected to the control device, a first plug configured at a far end away from the control device; and
a third auxiliary cable connected to the control device, a first port configured at a far end of the second auxiliary cable away from the control device;
wherein the main cable and the first auxiliary cable provide both electricity transmission and signal communication for the main controller IC; and
the first port and the first plug are compatible connectors so that the first plug is capable of being plugged into the first port of a separate lamp string.
